(19) United States
(12) Patent Application Publication
(10) Pub. No.: US 2012/0298681 A1
(43) Pub. Date: Nov. 29, 2012

(54) WATER HEATER HANDLE

(75) Inventor: HAROLD RICHARD NUGENT, Fuquay-Varina, NC (US)

(73) Assignee: Nugent Plumbing and Pumps, Fuquay Varina, NC (US)

(21) Appl. No.: 13/478,686

(22) Filed: May 23, 2012

Related U.S. Application Data
(60) Provisional application No. 61/519,393, filed on May 23, 2011.

(51) Int. Cl. F24H 9/00; B23P 11/00; B65D 25/28

(52) U.S. Cl. 220/759; 220/768; 29/428

(57) ABSTRACT

A water heater handle to be held by a user, where one end is configured to be held by the user and the other end is configured for connection to a water heater by existing fittings on the water heater. The handle and method of using the handle provide improved movement of the water heater by a user, through provision of a handle for gripping and/or stabilizing the water heater during movement, where such grip and stabilization is difficult in the absence of a handle.

### CROSS REFERENCE TO RELATED APPLICATIONS

This application claims the benefit of U.S. Provisional Application No. 61/519,393, filed May 23, 2012, titled “WATER HEATER HANDLE.” The disclosure of the foregoing application is hereby incorporated herein by reference in its entirety, for all purposes, and the priority of such application is hereby claimed.

### FIELD OF THE INVENTION

The present invention relates to a handle for moving a water heater. The invention contemplates a handle for attachment to a water heater and a method of using the same in movement of a water heater, where one portion of the handle is configured to be held by a user and a second portion of the handle is configured for attachment to a water heater.

### DESCRIPTION OF THE RELATED ART

In the use and operation of conventional tank water heaters, both residential and commercial, there may arise a need to move the water heater. Such movement may be for installation of a water heater, for removal of a water heater or a temporary or permanent relocation of an existing water heater for repairs to the water heater, redesign of spaces around the water heater, or other similar construction needs.

Typically, a water heater is empty when moved. Accordingly, if the water heater is already full, the water should be drained prior to the movement of the water heater. However, even empty, water heaters can be quite heavy. The weight will vary, based on brand, design, quality, composition, age, capacity, etc. A residential water heater is generally within the range of 30-100 gallons. A new, empty 40 gallon water heater, for example, can weigh up to 200 pounds. New commercial water heaters may be even larger and heavier. It is well known that after years of use, sediment or other debris from the water may settle out of the water and accumulate in the water heater. The presence of such sediment or other debris can add further weight to an older water heater, even when drained.

In addition to considerations of weight in moving a water heater, plumbers and other construction professionals also need to consider the size and shape of a water heater. Typical residential water heaters are cylindrical in shape and can be over 6 feet tall. When it is further considered that water heaters are generally positioned at least 18 inches off the ground, a professional faced with moving a water heater may be considering how to move an apparatus with a top height of almost 8 feet. The cylindrical shape and smooth exterior also make finding a place to grip the water heater difficult. With a diameter in the range of 15-30 inches, it is also difficult, if not impossible, to grip around the water heater.

Still further, moving a water heater must include consideration of positioning of the water heater in the residence or business. Generally, water heaters are placed in the basement or on the ground floor of a residence, however some homes have attic or other ceiling space positioning and others have more localized positioning for smaller, more immediate hot water needs, such as in bathrooms and kitchens located further away from the main water heater. Such placements may include challenges such as low clearance, stairs to reach the intended destination, unfinished areas of a house and the like.

Tools and methods for moving water heaters must therefore take into account many challenges, such as the forementioned challenges of weight, size, shape and positioning. Additionally, the exterior of water heaters are typically smooth and don't provide handholds or structurally secure components for gripping the water heater and lifting its full weight or means for stabilization of the water heater during movement.

While movement may be possible simply by lifting the water heater, such repeated lifting and positioning over a longer term may result in injuries to the professional. In consideration of avoiding such injuries and other known challenges, many systems have been devised for movement of water heaters. One such solution includes putting the entire water heater into a specially designed bag with exterior handles or straps to allow for gripping, lifting and/or stabilizing the water heater. Other such solutions involve elaborate strap or other systems secured around the water heater for use in movement of the water heater. Once a handle, strap, loop or other means for moving the water heater is established, the professional may move the water heater under his or her own power, or may choose to use an assisted method, employing a lift and pulley system, winch, cornealong, handtruck or other such tool.

However, moving water heaters still remains a challenging job for plumbers and other professionals. Often such professionals work alone, so tools that require the power of more than one person may not be practical options in a real world setting. Additionally, professionals may not have the mechanical tools, financial means or time to implement complicated lift and pulley systems and may need to rely upon their own power to move and place water heaters. Accordingly, one solution for water heater movement will provide a good grip, preferably a hand-held grip, of an entire water heater for a single installer, will be simple to install and remove and will be cost effective.

In consequence, the art continues to seek improvements in tools to assist in moving water heaters. This invention provides a method and apparatus for movement of water heaters.

### SUMMARY OF THE INVENTION

The present invention relates to a water heater handle and methods of using the same.

In one aspect, the invention relates to a water heater handle, comprising: an upper portion defining an opening, wherein the opening is configured to form a handhold to be held by a user so that the handle enables the water heater to be manually translated and positioned by a user holding the handle; and a lower portion comprising a connector adapted for attachment to a water heater inlet or outlet to secure the handle to the water heater.

In another aspect, the invention relates to a method of moving a water heater comprising use of a water heater handle of the invention.

In a further aspect, the invention relates to a method of moving a water heater comprising: attaching at least one water heater handle to a water heater, the handle comprising an upper portion defining an opening, wherein the opening is configured to form a handhold to be held by a user so that the handle enables the water heater to be manually translated and positioned by a user holding the handle; and a lower portion comprising a connector adapted for attachment to a water heater inlet or outlet to secure the handle to the water heater; and using the handle to move the water heater.

Other aspects, features and embodiments of the invention will be more fully apparent from the ensuing disclosure and appended claims.

### BRIEF DESCRIPTION OF THE DRAWINGS

FIG. 1 is a photograph of an exemplary water heater handle of the invention illustrating the general shape of such a handle.

FIG. 2 is a photograph of a water heater handle of the invention with identification of particular elements as described in Example 1 herein.

FIG. 3 is a photograph of a water heater handle of the invention attached to a water heater.

FIG. 4 is a close up photograph of a water heater handle of the invention attached to a water heater.

### DETAILED DESCRIPTION OF THE INVENTION, AND PREFERRED EMBODIMENTS THEREOF

The present invention relates to a handle for improved movement of a water heater. A water heater handle of the invention generally has a first portion useful as a secure handhold for gripping and a second portion useful as a connector for connection to a water heater. By use of such a handle, a handhold for movement of a water heater is provided, where the handle is securely connected to the existing water heater apparatus. The present disclosure provides both a water heater handle and method of use.

Movement of water heaters can be cumbersome and difficult for a user, due to factors such as the weight, size, shape, and positioning of water heaters. A handle of the invention securely attaches to a water heater and provides a user with a handhold for use in the movement and/or stabilization of the water heater.

Generally, water heaters do not possess handholds for movement of the water heater. Protrusions or indentations of the smooth exterior of a water heater are usually limited to an inlet for cold water intake, an outlet for hot water produced, and an exhaust flue, generally located on the top of the water heater; and an outlet for draining, burner control, and pressure/temperature relief valve, generally located on the sides of the water heater, and piping relating to the same. Many of these valves, drains and pipes are small and/or not configured for gripping and therefore cannot function as load-bearing handholds for movement of a water heater.

The present invention provides a handle with two portions, an upper portion with a handhold for a user and a lower portion for attachment to a water heater. As used herein, the handhold may also be referred to as a “grip point.” The handhold may be sized such that the user can place one or two hands on the handhold in movement of a water heater. In a particular configuration, when attached to a water heater, the handhold is positioned distally from the water heater. The handhold, when gripped by the user, provides a secure grip for movement of a water heater.

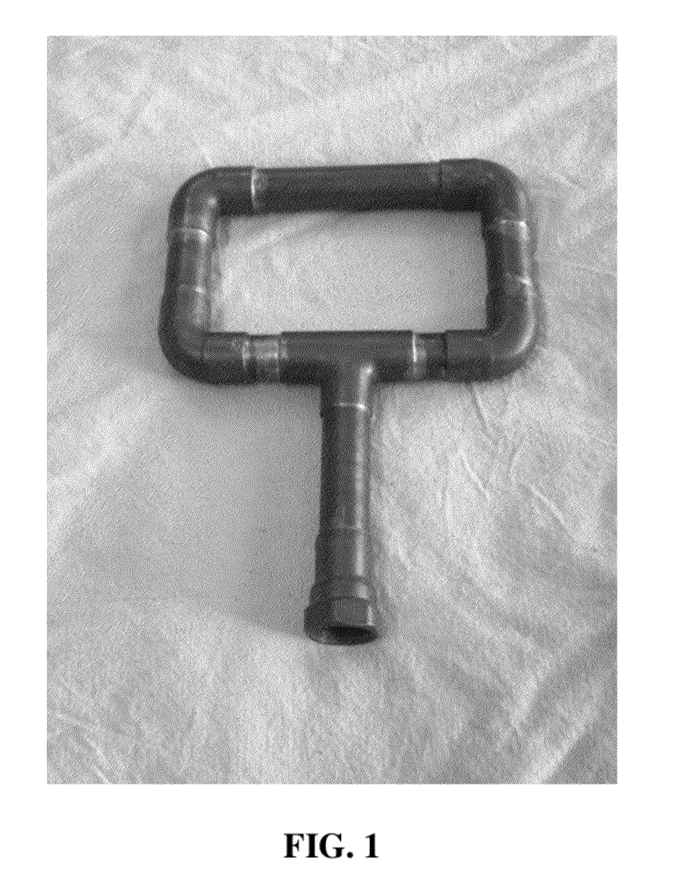

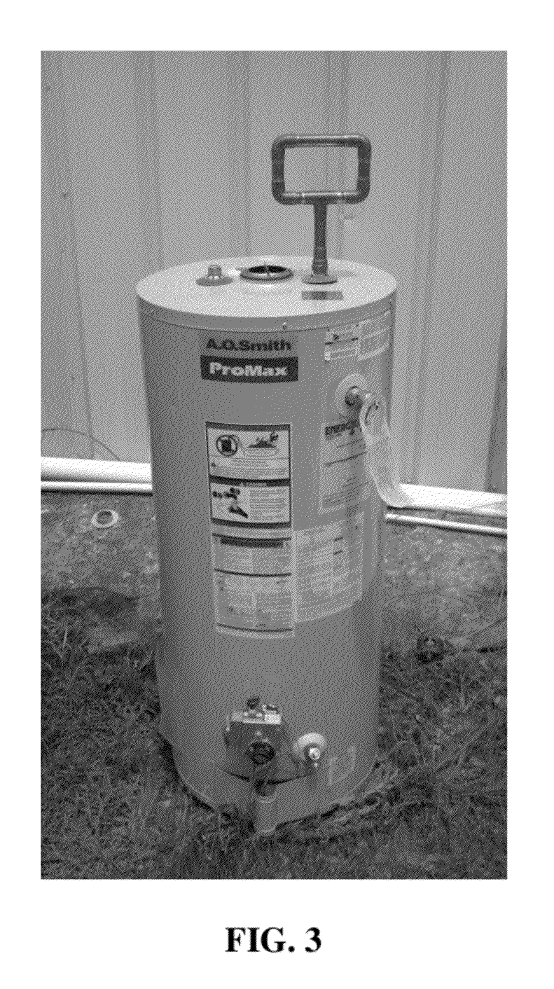

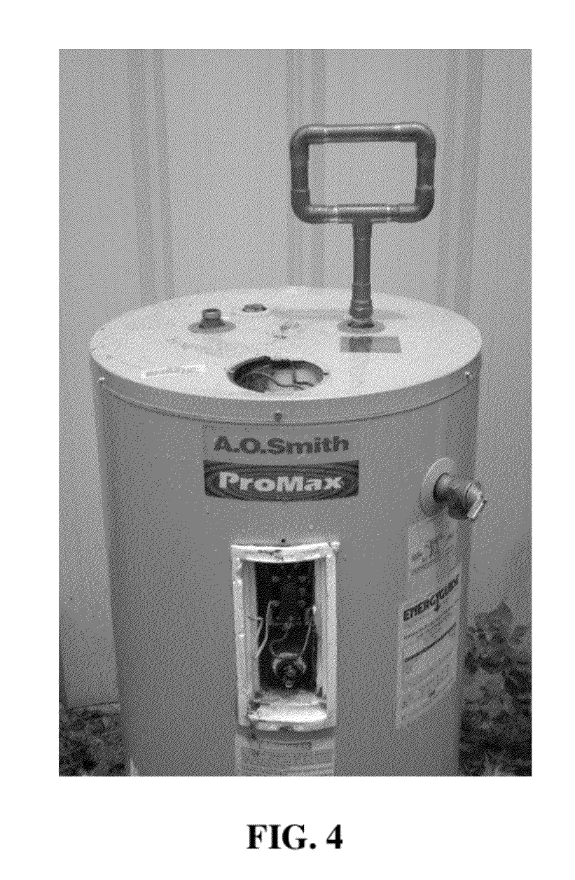

The upper portion of a handle of the invention has an opening that defines the handhold or grip point. The opening is substantially quadrilaterally shaped, such that it has four sides, the uppermost side providing the portion for gripping. In one embodiment, the opening is substantially rectangular. FIGS. 1-4 illustrate exemplary handles of the invention with substantially rectangular openings. However the shape of the opening may be any shape that provides a handhold for the user. As described herein, the shapes are substantially as described, but may have rounded edges or rounded lateral lengths, as useful to provide a handhold for placement of a user's hand.

The lower portion of a handle of the invention has a connector that is adapted for removable attachment to a water heater. Generally water heaters contain at least one inlet for cold water and at least one outlet for hot water. At the locus of each inlet or outlet is provided a “fitting,” also referred to as a “nipple,” that in operation of a water heater is connected to a pipe to transport water to or from the heater. However, prior to connection of such pipes for transport of water, the fitting provides a protrusion from the water heater, to which a handle may be securely attached through the connector. In one embodiment, a handle may be attached to a cold water inlet fitting. In another embodiment, a handle may be attached to a hot water outlet fitting.

Additionally, water heaters contain a drain outlet for drainage of the water from the water heater. Such drain outlet is generally located near the bottom of the water heater, such that drainage of the water is gravity-assisted. A drain outlet fitting may provide an additional location for attachment of a handle to a water heater. On some water heaters, the drain itself may be removed, leaving behind a fitting. In one embodiment, a handle may be attached to a drain outlet fitting.

Though cold water inlet, hot water outlet and drain outlet fittings are exemplified herein, attachment of a handle to any compatible fitting on a water heater is contemplated by the present invention. Handles of the invention may be utilized alone or in combination. In still another embodiment, more than one handle may be attached to more than one fitting. For example, a first handle may be attached to a cold water inlet fitting and a second handle may be attached to a hot water outlet fitting. In another example, a first handle may be attached to either of a cold water inlet fitting or a hot water outlet fitting and a second handle may be attached to a drain outlet fitting.

The attachment of the handle to a water heater is a secure attachment, which will permit movement and positioning of the water heater by a user holding the handle. The attachment may be by any means that provides such a secure attachment. Further, the attachment is temporary and removable once the water heater has been moved and positioned, as desired.

In one embodiment, the fitting is threaded and the connector of the lower portion of the handle has compatible threading, such that the two components may be directly attached to one another. Either of the fitting or the connector may be male and the other female, resulting in a threaded coupling of the components. In one embodiment the fitting is male and the connector is female. In a further embodiment, where the fitting and the connector are both female or are both male or are otherwise not directly compatible for attachment, an adapter may be included in order to attach the handle to the water heater. Such adapter may be of any type to permit attachment of the handle to the water heater.

In one embodiment, the upper portion of a handle and the lower portion of the handle are substantially coplanar with respect to each other. Such arrangement will provide the user the ability to exert force on the handhold and have force translated to a water heater for movement of the water heater. However, in alternative embodiments, the upper portion of a handle and the lower portion of the handle may be arranged in any manner sufficient to provide a handhold for the user and a connector to a water heater, where the handle is useful in movement of a water heater.

The size, shape, length, etc., of a handle of the invention may be varied, as necessary, in view of the characteristics of the water heater to be moved. The particular situation may include consideration of the size of the water heater, weight of the water heater, position of the water heater, movement to be accomplished, the size of the user, and the strength of the user. Other conditions may be evaluated, in order to determine the specifications of the handle necessary to accomplish movement of the water heater.

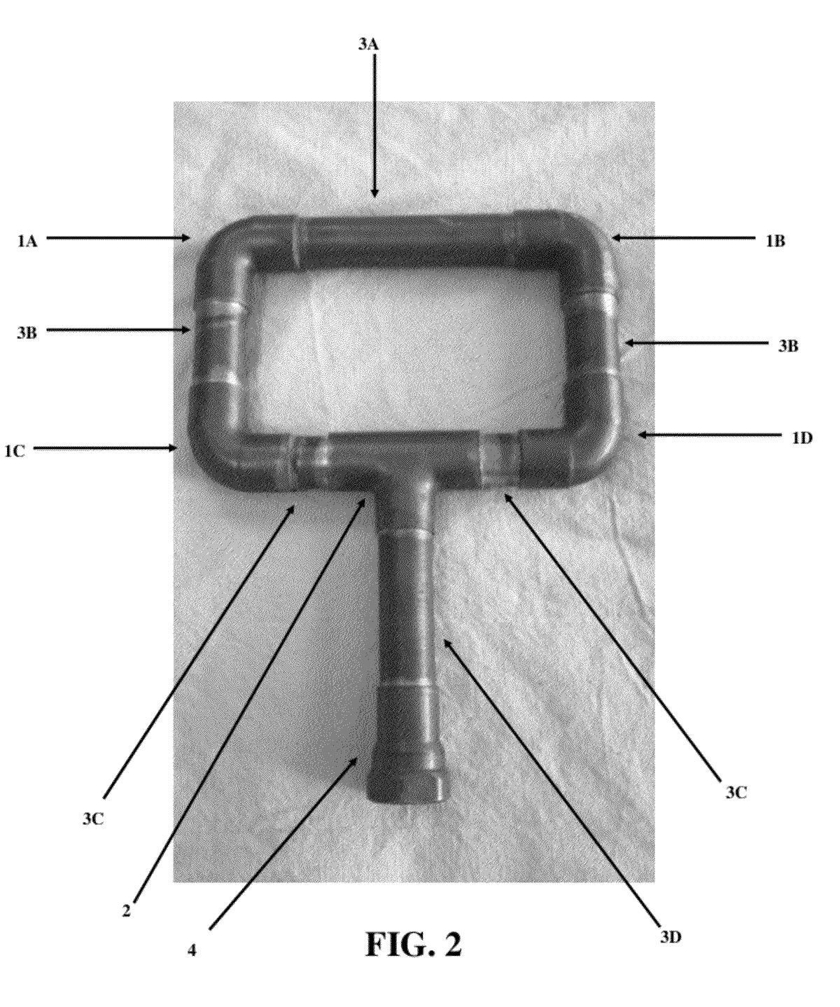

The upper and lower portions of a handle of the invention may comprise individual pieces or may be a single piece. In one embodiment, an entire handle is a single piece. In another embodiment, a handle is comprised of two or more pieces. In a particular embodiment, a handle comprises individual pipes, assembled to form the handle. FIG. 2 provides an example of such an assembled handle, with lengths of pipe 3A, 3B, 3C and 3D, elbows 1A, 1B, 1C and 1D, a tee 2 and an adapter 4. The handle of FIG. 2 is described in detail in Example 1 below.

Where a handle of the invention comprises one or more pipes, the pipes may comprise brass, aluminum, copper, steel, metal alloys, plastic or combinations thereof. The pipes may be of any material suitable for connection to the water heater and movement of such water heater. A handle comprised of such pipes must be strong enough to permit movement of the water heater.

As described herein, “movement” of a water heater may be any translation of the water heater from an initial position to a final position. The initial position and the final position may be the same as or different from one another. Movement may include, but is not limited to, installation or removal of a water heater, shifting of a water heater, carrying a water heater, and raising or lowering of a water heater. Movement may include tipping, shifting, raising, or lowering a water heater. Movement may be along a plane that is horizontal, vertical, parallel, perpendicular, lateral, diagonal, or any combination thereof, relative to the initial position of a water heater. Movement may also be referred to herein as translation. In a particular embodiment, the invention provides for manual translation of a water heater, such that by using a handle of the invention, a water heater may be moved under power supplied by the user.

Therefore in one embodiment, the invention provides a water heater handle, comprising an upper portion defining an opening, wherein the opening is configured to form a handhold to be held by a user so that the handle enables the water heater to be manually translated and positioned by a user holding the handle; and a lower portion comprising a connector adapted for attachment to a water heater inlet or outlet to secure the handle to the water heater.

In another embodiment, the invention relates to a method of moving a water heater comprising use of a water heater handle as described herein.

Movement of a water heater is as described in detail herein. In one embodiment, the movement is manually powered by the user. In another embodiment, the movement may be powered by mechanical means, such as a winch or a handtruck. In a further embodiment, power is provided by a combination of manual and mechanical means. Regardless of the type of movement, a handle is provided as a handhold or grip point for the user. The handhold or grip point may be the application point for all force used to move a water heater or it may be a stabilization point for the user, while the force for movement is applied elsewhere on the water heater.

In one embodiment, a handle of the invention is sufficient to support the full weight of a water heater when manually translated by a user. In another embodiment, the handle is used in a steadying or supporting manner when a water heater is moved. In a still further embodiment, the one or more handles are used as a locus for connection or attachment of a winch or other mechanical means useful in moving a water heater.

Additionally, attachment of more than one handle to a water heater is contemplated by the invention. In one embodiment, the invention comprises attachment of a handle to the inlet and outlet fittings and/or to the drain outlet fitting, providing multiple handholds for the user or users. In a particular embodiment, a method of the invention includes attachment of two handles to a water heater.

In a further embodiment, the invention provides a method of moving a water heater comprising attaching at least one water heater handle to a water heater, the handle comprising an upper portion defining an opening, wherein the opening is configured to form a handhold to be held by a user so that the handle enables the water heater to be manually translated and positioned by a user holding the handle; and a lower portion comprising a connector adapted for attachment to a water heater inlet or outlet to secure the handle to the water heater; and using the handle to move the water heater.

In a further embodiment the invention provides a method comprising use of more than one handle for movement of a water heater. In a further embodiment the invention provides a method comprising use of one handle attached to a water heater in combination with one or more pipes attached to other components of the water heater, e.g. a handle on the drain outlet fitting and one or more pipes (sawed off or intact, as necessary) attached to and extending from a cold water inlet and/or a hot water outlet.

The advantages and features of the invention are further illustrated with reference to the following example, which is not to be construed as in any way limiting the scope of the invention but rather as illustrative of one embodiment of the invention in a specific application thereof.

### Example 1

A water heater handle of the type shown in FIG. 1 may be employed in the movement of a water heater. An exemplary water heater handle has been developed with the following specifications, indicated with respect to the reference numerals of FIG. 2.

A female pipe adapter 4 is provided at the proximal end of the water heater handle, closest to the water heater, when attached. Such adapter provides a thread adapter for secure connection to either of the hot or cold fittings on the water heater. To the distal end of the adapter, a 4¾ inch length of pipe 3D was attached. To the open end of the pipe 3D, a ¾ inch “T” pipe 2 was attached. To each open end of the “T” pipe 2, a 2¾ inch length of pipe 3C was attached, such that pipes 3C are essentially perpendicular to pipe 3D. A ¾ inch elbow pipe 1C, 1D was attached to the open end of each of 2¾ inch pipes 3C. A 3¾ inch length of pipe 3B was then attached to the open end of each of the elbow pipes 1C, 1D, such that pipes 3B are essentially perpendicular to pipes 3C and parallel to pipe 3D. A ¾ inch elbow pipe 1A, 1B was attached to the open end of each of 3¾ inch pipes 3B. A 5¾ inch length of pipe 3A was attached to both of the open ends of elbow pipes 1A, 1B, such that pipe 3A is essentially perpendicular to pipes 3B and 3D and parallel to pipes 3C. The connected pipe 3A and top portions of elbow pipes 1A, 1B form the handheld end of the water heater handle, while the adapter 4 provides proximal end for connection to a suitable inlet fitting on the water heater.

While the invention has been has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

What is claimed is:

1. A water heater handle, comprising:
an upper portion defining an opening, wherein the opening is configured to form a handhold to be held by a user so that the handle enables the water heater to be manually translated and positioned by a user holding the handle; and
a lower portion comprising a connector adapted for attachment to a water heater inlet or outlet to secure the handle to the water heater.

2. The water heater handle of claim 1, wherein the upper portion is substantially quadrilaterally shaped.

3. The water heater handle of claim 1, wherein the connector comprises threads compatible with threads on the water heater inlet or outlet, such that the attachment is a threaded coupling of the connector and the inlet or outlet.

4. The water heater handle of claim 1, further comprising an adapter to connect the connector to the water heater inlet or outlet.

5. The water heater handle of claim 1, wherein the upper and lower portions are substantially coplanar with respect to each other.

6. The water heater handle of claim 1, wherein the upper and lower portions comprise pipes.

7. The water heater handle of claim 6, wherein the pipes comprise brass, aluminum, copper, steel, metal alloy, or plastic.

8. The water heater of claim 1, wherein the connector is adapted for attachment to any of a cold water inlet fitting, a hot water outlet fitting and a drain outlet fitting.

9. A method of moving a water heater comprising use of a water heater handle of claim 1.

10. A method of moving a water heater comprising:
attaching at least one water heater handle to a water heater, the handle comprising:
an upper portion defining an opening, wherein the opening is configured to form a handhold to be held by a user so that the handle enables the water heater to be manually translated and positioned by a user holding the handle; and
a lower portion comprising a connector adapted for attachment to a water heater inlet or outlet to secure the handle to the water heater;
using the handle to move the water heater.

11. The method of claim 10, wherein the upper portion is substantially quadrilaterally shaped.

12. The method of claim 10, wherein the connector comprises threads compatible with threads on the water heater inlet or outlet, such that the attachment is a threaded coupling of the connector and the inlet or outlet.

13. The method of claim 10, further comprising an adapter to connect the connector to the water heater inlet or outlet.

14. The method of claim 10, wherein the upper and lower portions are substantially coplanar with respect to each other.

15. The method of claim 10, wherein the upper and lower portions comprise pipes.

16. The method of claim 15, wherein the pipes comprise brass, aluminum, copper, steel, metal alloy, or plastic.

17. The method of claim 10, wherein the connector is adapted for attachment to any of a cold water inlet fitting, a hot water outlet fitting and a drain outlet fitting.

18. The method of claim 10, wherein two water heater handles are attached to the water heater.

19. The method of claim 18, wherein the handles are attached to any of a cold water inlet fitting, a hot water outlet fitting and a drain outlet fitting.
